(19) United States
(12) Patent Application Publication
(10) Pub. No.: US 2006/0147791 A1
(43) Pub. Date: Jul. 6, 2006

(54) Platinum recovery from fuel cell stacks

(76) Inventors: Mark K. Debe, Stillwater, MN (US); Clayton V. Hamilton JR., Woodbury, MN (US)

Correspondence Address: 3M INNOVATIVE PROPERTIES COMPANY, PO BOX 33427, ST. PAUL, MN, 55133-3427, US

(21) Appl. No.: 11/026,986

(22) Filed: Dec. 30, 2004

(51) Int. Cl. H01M 8/00; A62D 3/00; B01J 15/00

(52) U.S. Cl. 429/49; 429/12; 588/412; 422/164

(57) ABSTRACT

A method and apparatus is provided for recovering platinum metal from a fuel cell stack without disassembly, burning or electrolysis by introducing an oxidizing acidic solution to at least one of the ports of the stack. The method may additionally include the subsequent step of precipitating a platinum salt from the oxidizing acidic solution.

This invention was made with Government support under Cooperative Agreement DE-FC36-02AL67621 awarded by the DOE. The Government has certain rights in this invention.

### FIELD OF THE INVENTION

This invention relates to recovery of platinum used as catalyst in fuel cell equipment.

### BACKGROUND OF THE INVENTION

U.S. Pat. No. 5,879,827, the disclosure of which is incorporated herein by reference, discloses nanostructured elements comprising acicular microstructured support whiskers bearing acicular nanoscopic catalyst particles. The catalyst particles may comprise alternating layers of different catalyst materials which may differ in composition, in degree of alloying or in degree of crystallinity.

U.S. Pat. App. Pub. No. 2002/0004453 A1, the disclosure of which is incorporated herein by reference, discloses fuel cell electrode catalysts comprising alternating platinum-containing layers and layers containing suboxides of a second metal that display an early onset of CO oxidation.

U.S. Pats. Nos. 5,338,430, 5,879,828, 6,040,077 and 6,319,293, the disclosures of which are incorporated herein by reference, also concern nanostructured thin film catalysts.

U.S. Pats. Nos. 4,812,352, 5,039,561, 5,176,786, and 5,336,558, the disclosures of which are incorporated herein by reference, concern microstructures.

U.S. patent application Ser. No. 10/674,594, the disclosure of which is incorporated herein by reference, discloses fuel cell cathode catalysts comprising nanostructures formed by depositing alternating layers of platinum and a second layer onto a microstructure support, which may form a ternary catalyst.

JP60184647A (English abstract) purportedly describes the recovery of an amount of noble metal from a fuel cell by a particular method, which includes steps of electrolysis or electrolytic oxidation, where the noble metal is leached into an electrolytic solution which is fed to the electrode, which contains an ion or a ligand which forms a complex ion with the noble metal and makes the noble metal soluble.

European Patent Application Publication No. 1 065 742 A2 purportedly describes a particular method of recovering electrolytic membrane from a fuel cell, which may include the steps of removing a membrane electrode assembly from a fuel cell stack and soaking it in methanol to remove the electrodes from the electrolytic membrane.

U.S. Pat. No. 4,775,452 purportedly describes the recovery of an amount of noble metal from catalysts in particulate form by a particular electrolytic process carried out in a electrolytic cell.

U.S. Pat. No. 5,133,843 purportedly describes a particular process of recovering an amount of metal found in particular forms on or in the membranes of electrochemical cells which may include a step of treatment with an inorganic acid such as aqua regia.

One standard method of recovering platinum from fuel cell parts is by burning the parts and recovering platinum from the resulting ash. Larger parts, such as fuel cell stacks, may be or may need to be chopped prior to burning.

### SUMMARY OF THE INVENTION

Briefly, the present invention provides a method of recovering platinum metal from a fuel cell stack, which comprises platinum-containing catalyst and which comprises one or more ports allowing access to the platinum-containing catalyst, where the method comprises the step of introducing an oxidizing acidic solution to at least one of the ports. The method may additionally include the step of removing the oxidizing acidic solution from at least one of the ports. The method may additionally include the subsequent step of precipitating a platinum salt from the oxidizing acidic solution. The method may additionally include the subsequent step of calcining the platinum salt. The oxidizing acidic solution typically comprises at least one acid and at least one oxidizing agent, which may be a peroxide such as hydrogen peroxide. The oxidizing acidic solution typically comprises at least one strong acid such as hydrochloric acid. The oxidizing acidic solution may be aqua regia. One embodiment of the method of present invention additionally comprises the subsequent step of using the oxidizing acidic solution as an electroplating solution. One embodiment of the method of present invention additionally comprises the subsequent step of using the calcined platinum salt to manufacture fuel cell catalyst.

In another aspect, the present invention provides an apparatus for recovery of platinum metal from a fuel cell stack which comprises platinum-containing catalyst and which comprises one or more ports allowing access to the platinum-containing catalyst, the apparatus comprising a first connector adapted for attachment to a first port and a first reservoir for an oxidizing acidic solution functionally connected to the first connector such that the oxidizing acidic solution may be introduced into the first port. The apparatus may additionally comprise a pump functionally connected to the first reservoir and first connector such that the pump can move oxidizing acidic solution from the first reservoir to the first connector. The apparatus may additionally comprise a second connector adapted for attachment to a second port, where the second connector is functionally connected to the reservoir such that the oxidizing acidic solution may be removed from the second port into the first reservoir. Alternately, the second connector is functionally connected to a second reservoir such that the oxidizing acidic solution may be removed from the second port into the second reservoir.

What has not been described in the art, and is provided by the present invention, is a quick and efficient method and apparatus for removing platinum from a fuel cell stack without disassembly.

In this application:

“membrane electrode assembly” means a structure comprising a membrane that includes an electrolyte, typically a polymer electrolyte, and at least one but more typically two or more electrodes adjoining the membrane;

“nanostructured element” means an acicular, discrete, microscopic structure comprising a catalytic material on at least a portion of its surface;

“nanoscopic catalyst particle” means a particle of catalyst material having at least one dimension equal to or smaller than about 15 nm or having a crystallite size of about 15 nm or less, as measured from diffraction peak half widths of standard 2-theta x-ray diffraction scans;

“acicular” means having a ratio of length to average cross-sectional width of greater than or equal to 3;

“discrete” refers to distinct elements, having a separate identity, but does not preclude elements from being in contact with one another; and

“microscopic” means having at least one dimension equal to or smaller than about a micrometer.

It is an advantage of the present invention to provide a quick, efficient and selective method and apparatus for removing platinum from a fuel cell stack without disassembly or burning.

### BRIEF DESCRIPTION OF THE DRAWING

FIG. 1 is a graph of time for complete removal of Pt from a catalyst coated membrane (CCM) by methods according to the present invention as a function of temperature for each of three concentrations of aqua regia, as described in Example 1 below.

FIG. 2 is a graph of time for complete removal of Pt from a CCM by methods according to the present invention as a function of temperature for each of three concentrations of HCl/peroxide, as described in Example 3 below.

### DETAILED DESCRIPTION

The present invention provides a method of recovering platinum metal from a catalyst-coated membrane comprising nanostructured elements by a process which includes exposing the catalyst-coated membrane to an oxidizing acidic solution.

Fuel cell catalysts typically contain significant amounts of platinum. The catalyst is typically found in the membrane electrode assembly (MEA) of the fuel cell. An MEA is the central element of a proton exchange membrane fuel cell, such as a hydrogen fuel cell. Fuel cells are electrochemical cells which produce usable electricity by the catalyzed combination of a fuel such as hydrogen and an oxidant such as oxygen. Typical MEA's comprise a polymer electrolyte membrane (PEM) (also known as an ion conductive membrane (ICM)), which functions as a solid electrolyte. One face of the PEM is in contact with an anode electrode layer and the opposite face is in contact with a cathode electrode layer. Each electrode layer includes electrochemical catalysts, typically including platinum metal. In typical use, protons are formed at the anode via hydrogen oxidation and transported across the PEM to the cathode to react with oxygen, causing electrical current to flow in an external circuit connecting the electrodes. The PEM forms a durable, non-porous, electrically non-conductive mechanical barrier between the reactant gases, yet it also passes H⁺ ions readily. Gas diffusion layers (GDL's) facilitate gas transport to and from the anode and cathode electrode materials and conduct electrical current. The GDL is both porous and electrically conductive, and is typically composed of carbon fibers. The GDL may also be called a fluid transport layer (FTL) or a diffuser/current collector (DCC). In some embodiments, the anode and cathode electrode layers are applied to GDL's and the resulting catalyst-coated GDL's sandwiched with a PEM to form a five-layer MEA. The five layers of a five-layer MEA are, in order: anode GDL, anode electrode layer, PEM, cathode electrode layer, and cathode GDL. In other embodiments, the anode and cathode electrode layers are applied to either side of the PEM, and the resulting catalyst-coated membrane (CCM) is sandwiched between two GDL's to form a five-layer MEA.

In various embodiments, the present invention may be carried out using fuel cell parts for fuel cells designed for operation on various fuels, including hydrogen, reformate, methanol, and the like.

The PEM is typically comprised of a polymer electrolyte. The polymer electrolyte typically bears anionic functional groups bound to a common backbone, which are typically sulfonic acid groups but may also include carboxylic acid groups, imide groups, amide groups, or other acidic functional groups. The polymer electrolytes are typically highly fluorinated and most typically perfluorinated, but may also be partially fluorinated or non-fluorinated. The polymer electrolytes are typically copolymers of tetrafluoroethylene and one or more fluorinated, acid-functional comonomers. Typical polymer electrolytes include Nafion® (DuPont Chemicals, Wilmington Del.) and Flemion™ (Asahi Glass Co. Ltd., Tokyo, Japan). The polymer electrolyte may be a copolymer of tetrafluoroethylene (TFE) and FSO₂—CF₂CF₂CF₂CF₂—O—CF═CF₂, described in U.S. patent application Ser. Nos. 10/322,254, 10/322,226 and 10/325,278, which are incorporated herein by reference. The polymer typically has an equivalent weight (EW) of 1200 or less, more typically 1100 or less, and more typically 1000 or less. In addition to fluorinated membranes, membranes may include hydrocarbon polymers, including aromatic polymers. Examples of useful hydrocarbon polymers include sulfonated polyetheretherketone, sulfonated polysulfone, and sulfonated polystyrene.

Typical fuel cells use catalyst in forms including catalyst metal fines, conventional carbon-supported catalyst and nanostructured thin film catalyst comprising nanostructored elements and nanostructured catalyst particles.

Typical conventional carbon-supported catalyst particles are 50-90% carbon and 10-50% catalyst metal by weight, the catalyst metal typically comprising Pt for the cathode and Pt and Ru in a weight ratio of 2:1 for the anode. Typically, the catalyst is applied to the PEM or to the FTL in the form of a catalyst ink. Alternately, the catalyst ink may be applied to a transfer substrate, dried, and thereafter applied to the PEM or to the FTL as a decal. The catalyst ink typically comprises polymer electrolyte material, which may or may not be the same polymer electrolyte material which comprises the PEM. The catalyst ink typically comprises a dispersion of catalyst particles in a dispersion of the polymer electrolyte. The ink typically contains 5-30% solids (i.e. polymer and catalyst) and more typically 10-20% solids. The electrolyte dispersion is typically an aqueous dispersion, which may additionally contain alcohols and polyalcohols such a glycerin and ethylene glycol. The water, alcohol, and polyalcohol content may be adjusted to alter rheological properties of the ink. The ink typically contains 0-50% alcohol and 0-20% polyalcohol. In addition, the ink may contain 0-2% of a suitable dispersant. The ink is typically made by stirring with heat followed by dilution to a coatable consistency.

Nanostructured thin film catalysts comprising nanostructored elements and nanostructured catalyst particles are described in U.S. Pats. Nos. 5,338,430, 5,879,827, 5,879,828, 6,040,077 and 6,319,293, U.S. patent application Ser No. 10/674,594, and U.S. Pat. App. Pub. No. 2002/0004453 A1, the disclosures of which are incorporated herein by reference.

In use, the fuel cell MEA is typically sandwiched between two rigid plates, known as separator plates, also known as bipolar plates (BPP's) or monopolar plates. Like the GDL, the separator plate must be electrically conductive. The separator plate is typically made of a carbon composite, metal, or plated metal material. The separator plate distributes reactant or product fluids to and from the MEA electrode surfaces, typically through one or more fluid-conducting channels engraved, milled, molded or stamped in the surface(s) facing the MEA(s). These channels are sometimes designated a flow field. The separator plate may distribute fluids to and from two consecutive MEA's in a stack, with one face directing fuel to the anode of the first MEA while the other face directs oxidant to the cathode of the next MEA (and removes product water), hence the term “bipolar plate.” Alternately, the separator plate may have channels on one side only, to distribute fluids to or from an MEA on only that side, which may be termed a “monopolar plate.” The term bipolar plate, as used in the art, typically encompasses monopolar plates as well. In addition, bipolar or monopolar plates may comprise internal or external cooling channels.

A typical fuel cell stack comprises a number of MEA's stacked alternately with bipolar plates. Seals and gaskets are typically provided to maintain the integrity of the fluid passages. In addition, the entire stack is typically maintained under compression by appropriate mechanisms so as to maintain the integrity of the fluid passages. The stack typically comprises ports where fuel, oxidant (typically oxygen, air, or a gas mixture including oxygen), unused fuel, unused oxidant and product water can enter or leave the stack. Most typically, the stack comprises four ports: a fuel inlet port, a fuel outlet port, a oxidant inlet port and an oxidant outlet port. Typically, a stack of a given design will require a specified connector for attachment to each port.

In one embodiment of the present invention, platinum is recovered from nanostructured elements in a fuel cell CCM. The CCM may be incorporated in an MEA or a fuel cell stack. In this method, the CCM is exposed to an oxidizing acidic solution. The conditions and composition of the oxidizing acidic solution are typically such that a large proportion of the platinum in the CCM is dissolved. The oxidizing acidic solution typically comprises at least one acid and at least one oxidizing agent. The oxidizing agent may be any suitable oxidizing agent, including peroxides such as hydrogen peroxide, ozone, and the like and acidic oxidizing agents such as nitric acid, phosphoric acid, sulfuric acid, and the like. The acid may be any suitable acid, which is typically a strong acid such as HCl or the like. The oxidizing acidic solution may be aqua regia. The oxidizing acidic solution may be a solution of HCl and hydrogen peroxide. The oxidizing acidic solution may be in any suitable solvent, typically including water. The oxidizing acidic solution may additionally include surfactants, which may aid in the penetration of the solution into the GDL and throughout the fluid passages of an MEA or fuel cell stack. The oxidizing acidic solution may additionally include indicators for monitoring the condition of the solution, which might include indicators for platinum content, acidity, and other relevant factors. The oxidizing acidic solution may additionally include chelating agents.

Typically, the step of exposing the CCM to the oxidizing acidic solution has a duration of one hour or less, more typically 30 minutes or less, more typically 10 minutes or less, more typically 5 minutes or less.

In one embodiment of the present invention, the oxidizing acidic solution including dissolved platinum may be used for electroplating platinum, or the platinum may be removed from the solution by an electroplating process or other electrochemical process.

In one embodiment of the present invention, the oxidizing acidic solution including dissolved platinum is then treated so as to precipitate a platinum salt from the oxidizing acidic solution. In one embodiment of the present invention, a suitable counterion which forms an insoluble salt with platinum may be added. Typically, the chosen counterion is selective for platinum. Alternately, platinum ions may be separated from other ions prior to precipitation by methods such as ion exchange, use of chelating agents, electroplating, precipitation of the other ions, and similar methods.

In one embodiment of the present invention, the precipitated platinum salt is then calcined, typically by heating to a temperature of 500° C. or more, more typically 700° C. or more, and more typically 900° C. or more. The conditions of calcining are typically such that a relatively pure platinum metal is obtained, typically as a “sponge” or “cake”. The recovered platinum may be used for any purpose, including the manufacture of more fuel cell catalyst.

In one embodiment, the remains of the CCM comprise a polymer electrolyte membrane with C.I. PIGMENT RED 149 (PR-149 perylene red) particles attached to one or more faces and essentially no remaining platinum metal. This CCM may comprise the remains of an MEA or a fuel cell stack. If the treated CCM was not previously used in a fuel cell, i.e., if it is rejected or scrap material from a CCM fabrication process, the recovered PEM material is expected to be reusable. The PEM can be redissolved in solvents for recoating as a membrane and the perylene red whiskers removed by filtration.

In one embodiment of the present invention, platinum is recovered from a fuel cell stack without disassembly of the stack. The platinum present in the stack may be in any suitable form, including conventional carbon-supported catalyst, nanostructured thin film catalyst, metal fines, and the like. In this method, the oxidizing acidic solution described above is introduced into the stack through one or more of the ports of the stack. Typically, the oxidizing acidic solution is then recovered from the stack. In some embodiments, the recovered solution is treated as noted above, which may include use of the solution in an electroplating or electrochemical process or precipitation of a platinum salt from the recovered oxidizing acidic solution, possibly with subsequent calcining of the platinum salt. Typically these steps are carried out without application of an electric current to the stack.

The oxidizing acidic solution may be removed from the stack through the same or a different port than that through which it is introduced into the stack. In one embodiment, the oxidizing acidic solution is introduced through one of the fuel inlet or fuel outlet and removed through the other. In one embodiment, the oxidizing acidic solution is introduced through one of the oxidant inlet or oxidant outlet and removed through the other. A further embodiment includes both of the preceding embodiments, either occurring sequentially or more typically contemporaneously.

In one embodiment of the present invention, an apparatus is provided for recovery of platinum metal from a fuel cell stack. The apparatus comprises at least one connector adapted for attachment to a port of the stack and at least one reservoir for an oxidizing acidic solution. The reservoir is functionally connected to the connector such that the oxidizing acidic solution may be introduced into the first port. A pump may be provided to move the oxidizing acidic solution from the first reservoir to the first connector. In addition, a second connector may be provided for attachment to a second port, where the second connector is functionally connected to the same or a different reservoir such that the oxidizing acidic solution may be removed from the second port into the connected reservoir. In one embodiment, the apparatus includes four connectors, for connection to each of the fuel inlet, the fuel outlet, the oxidant inlet, and the oxidant outlet, and is capable of circulating oxidizing acidic solution through both of the fuel and the oxidant pathways of the stack. This apparatus may optionally be equipped with a pump for each pathway. This apparatus may optionally be equipped with a single pump for both pathways. This apparatus may optionally be equipped with one, two, three or four reservoirs. This apparatus may optionally be equipped with pressure gauge and or regulation equipment. This apparatus may optionally be equipped with equipment for heating, cooling or temperature regulation of solutions. This apparatus may optionally be equipped with equipment for safe venting and/or treatment of evolved gasses, which may include chlorine gas. This apparatus may optionally be equipped with computer-mediated control apparatus. This apparatus may optionally be equipped with apparatus to determine a desired reaction end point, such as a timer, a detector for concentration of Pt ions or other ions, a detector for any indicator as disclosed above, and the like.

This invention is useful in recycling of fuel cell parts.

Objects and advantages of this invention are further illustrated by the following examples, but the particular materials and amounts thereof recited in these examples, as well as other conditions and details, should not be construed to unduly limit this invention.

### EXAMPLES

Unless otherwise noted, all reagents were obtained or are available from Aldrich Chemical Co., Milwaukee, Wis., or may be synthesized by known methods.

Catalyst Coated Membranes (CCM's)

One of two types of CCM was used in each of the following Examples.

Nanostructured CCM's included a 30 micron thick, cast NAFION PEM and nanostructured thin film catalyst electrodes having 0.15 mg/cm² of Pt on the anode and 0.19 mg/cm² of Pt on the cathode. The cathode catalyst was in the form of a PtNiFe ternary catalyst with a loading of 0.19 mg/cm² Pt and 0.067 mg/cm² of 80:20 Ni:Fe (˜0.054 mg Ni/cm² and 0.0135 mg Fe/cm²) such as described in U.S. patent application Ser. No. 10/674,594, incorporated herein by reference. The catalyst coating is supported on a thin film of whiskers of C.I. PIGMENT RED 149 (PR-149 perylene red) organic pigment (available under the trade designation “13-4000 PV FAST RED 13” from Clariant, Coventry, R.I.) as taught generally in U.S. Pat. Nos. 4,812,352, 5,039,561, 5,176,786, 5,336,558, 5,338,430, 5,879,827, 5,879,828, 6,040,077 and 6,319,293, incorporated herein by reference. The coated whiskers are applied to the PEM by a dry lamination transfer process.

### Example 1

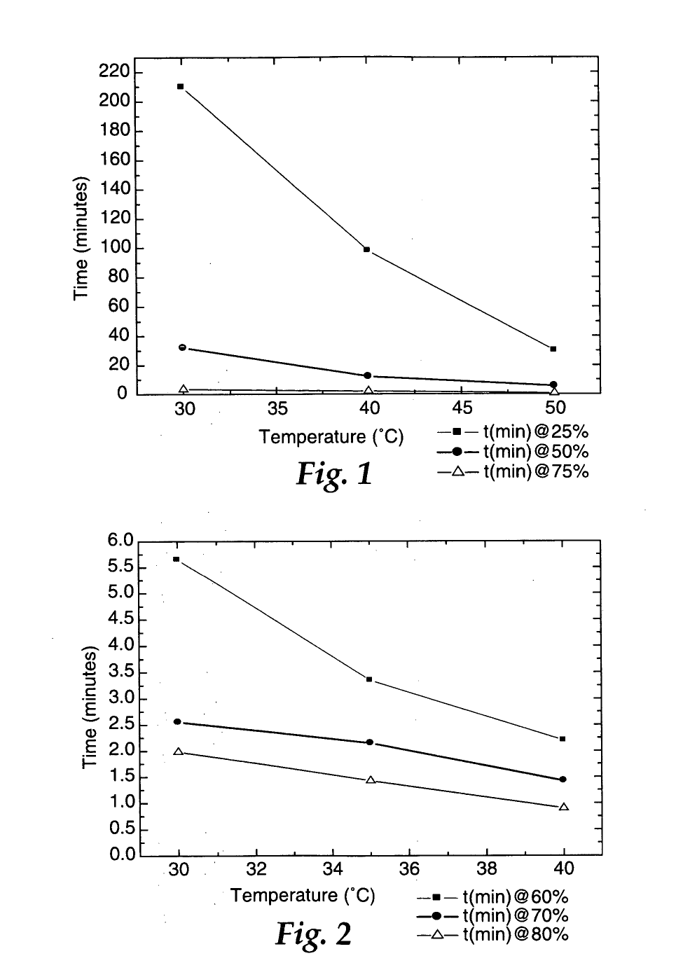

Small test strips of nanostructured CCM were immersed in different concentrations of aqua regia (3HCl+HNO₃) in deionized water (25%, 50% and 75% concentrations) at three temperatures (30° C., 40° C. and 50° C.), and the time required for removal of Pt from the CCM was noted. The end point was easily detected visually, since the nanostructured CCM changed from black to red in appearance once the Pt coating was removed from the C.I. PIGMENT RED 149 (PR-149 perylene red) organic pigment whiskers. The end point was taken to be complete color change. The test tubes holding the samples were shaken mildly during the exposure. The results are presented in Table I and FIG. 1.

TABLE I

| Run | Conc. (%) | Temp. (° C.) | Time (min.) |
|---|---|---|---|
| 1 | 25 | 30 | 210 |
| 2 | 75 | 30 | 3.50 |
| 3 | 25 | 50 | 30.0 |
| 4 | 75 | 50 | 0.72 |
| 5 | 25 | 40 | 98 |
| 6 | 75 | 40 | 2.00 |
| 7 | 50 | 30 | 32 |
| 8 | 50 | 50 | 5.5 |
| 9 | 50 | 40 | 12.2 |
| 10 | 50 | 40 | 12.5 |
| 11 | 50 | 40 | 12.0 |

The results indicate that an increase in either concentration or temperature reduces the time needed for Pt removal. In one run, Pt was removed from a nanostructured CCM in as little as 2 minutes using 75% aqua regia at 40° C. However, since high concentrations of aqua regia have a tendency to evolve chlorine gas, use of a 50% aqua regia/water solution at about 60° C. might be both easy to use and effective.

### Example 2

In this Example, Pt was extracted from nanostructured CCM material as described in Example 1 using 500 ml of 50% aqua regia in water at 60° C. The CCM was then rinsed in three successive one liter washes of deionized water, referred to as wash 1, wash 2 and wash 3. Inductively coupled plasma optical emission spectrometry (ICP) was used to determine concentration of elements in an aliquot of the various solutions. ICP of the acid extractant solution indicated a total content of 2.17 g of Pt, 0.09 g of Fe and 0.37 g of Ni. ICP analysis was also performed on each of the rinse baths. The amount of Pt in each of the rinses was: 0.263 g Pt (Wash 1), 0.012 g Pt (Wash 2) and 0.6 mg Pt (Wash 3) for a total of 2.45 g Pt removed from the CCM. Loose perylene red whiskers were noted in both the aqua regia solution and the three washes, due to agitation in the acid and wash solutions. The aqua regia solution containing the platinum was filtered through a glass filter pad to remove loose perylene red whiskers.

The filtrate was reduced to a volume of 100 milliliters by boiling. The chloroplatinic acid was then precipitated by the addition of 9 milliliters of a 5 molar solution of ammonium chloride (a 1.5 molar excess). The reaction is as follows:
2NH₄Cl+H₂PtCl₆→(NH₄)₂PtCl₆↓+2HCl

The recovery of ammonium chloroplatinate was 4.1729 g. The remaining supernatant solution contained 1.8 mg Pt, 5.3 mg Fe and 21 mg Ni, as determined by ICP. Thus, the precipitation step recovered about 99.9% of the Pt in the chloroplatinic acid.

The dried ammonium chloroplatinate precipitate was calcined at 1000° C. in a muffle furnace to give a Pt sponge. The theoretical recovery of platinum sponge from 4.1729 g of (NH₄)₂PtCl₆ is 1.8348 g. The actual recovery of platinum sponge was 1.8200 g. This indicates a 97.7% recovery in the calcining process. This represents a loss of 2.3% platinum to the calcining process. A small amount, 0.06507 g, of the Pt sponge was dissolved with concentrated hydrochloric acid, treated with hydrogen peroxide, diluted to 50 ml and analyzed by ICP. The sample was found to contain 99.25% Pt, 0.56% Ni and 0.19% Fe, and negligible amounts of Si, Na, Ti, Al, K, Zn, Mg and Zr, demonstrating that the Pt can be recovered with high purity.

In addition to recovery of Pt, the Example demonstrates separation of Pt from other elements, including Ni and Fe present in the catalyst. The initial amount of Ni and Fe contained on the CCM was 0.343 g Ni and 0.0857 g Fe. Since only 0.021 g of Ni and 0.0053 g of Fe were found in the filtrate of the precipitate, the remainder, 93.9% Ni and 93.8% Fe, remained in solution. This demonstrates the ability to easily purify the Pt from the multi-element catalysts.

### Example 3

HCl in combination with H₂O₂ was investigated as an alternative to aqua regia and found to be more effective in that less time at lower temperatures for recovering Pt from nanostructured thin film catalyst electrodes, and, in addition, the PR149 whisker support particles remained on the membrane.

Small test strips of nanostructured CCM were immersed in different concentrations of HCl/H₂O₂ (2.5 ml concentrated HCl to 1 ml of 30% H₂O₂) in deionized water (60%, 70% and 80% acid concentrations) at three temperatures (30° C., 35° C. and 40° C.), and the time required for removal of Pt from the CCM was noted. As in Example 1, the end point was easily detected visually, since the nanostructured CCM changed from black to red in appearance once the Pt coating was removed from the C.I. PIGMENT RED 149 (PR-149 perylene red) organic pigment whiskers. The end point was taken to be complete color change. The test tubes holding the samples were shaken mildly during the exposure. The results are presented in Table II and FIG. 2.

TABLE II

| Run | Conc. (%) | Temp. (° C.) | Time (min.) |
|---|---|---|---|
| 1 | 60 | 30 | 5.65 |
| 2 | 80 | 30 | 1.98 |
| 3 | 60 | 40 | 2.20 |
| 4 | 80 | 40 | 0.90 |
| 5 | 60 | 35 | 3.35 |
| 6 | 80 | 35 | 1.43 |
| 7 | 70 | 30 | 2.55 |
| 8 | 70 | 40 | 1.42 |
| 9 | 70 | 35 | 2.15 |
| 10 | 70 | 35 | 2.20 |
| 11 | 70 | 35 | 2.33 |

The results indicate that the time needed for Pt removal can be reduced by an increase in either concentration or temperature and by use of HCl/peroxide instead of aqua regia. Use of 85% HCl/peroxide solution at about 20° C. or at ambient temperature might be both easy to use an effective. This would require no added energy for heating. In fact, the reaction is slightly exothermic and therefore self-heats.

### Example 4

Pieces of nanostructured CCM totaling 5400 cm² in area, with a nominal Pt content of 13836 g. were treated with an oxidizing acidic solution prepared by addition of 40 ml of H₂O₂ to 250 ml of a solution of 85% concentrated HCl and 15% water (v/v). The total content of Pt in the CCM was nominally 1.3 g. The CCM was cut into strips and placed into the recovery reagent at ambient temperature, and shaken for a few minutes with frequent venting of gas having a chlorine odor. The reaction was noted to be mildly exothermic. The CCM strips were observed to change color from black to red (from the perylene red pigment whiskers left on the membrane) and the oxidizing acidic solution from clear to dark reddish brown.

The resulting brownish liquid was drained from the reaction vessel, and the strips of PR149 whisker coated Nafion subjected to five 50 ml washer with deionized water. Very little loose PR149 whiskers were noted in either the oxidizing acidic reagent or the subsequent washes. The reagent and washes were combined and reduced to about 132 ml in volume (140 g by weight) by heating in an open beaker. This reduced solution was then filtered. The solution in this form may be useable for electroplating Pt, e.g., in jewelry manufacturer.

Ammonium chloride was added to the chloroplatinic acid solution at room temperature with mild stirring, in the amounts of 3.5 molar equivalents, 1.5 molar excess. The precipitate was filtered from the supernatant solution and dried. The yellow ammonium chloroplatinate precipitate powder was placed on an ashless filter paper and calcined at 1000° C. in a muffle furnace. 1.93 g of platinum sponge was recovered per the reaction:
(NH₄)₂PtCl₆ [symbol] 2NH₄Cl↑+Pt⁰+2Cl₂↑
X-ray fluorescence was used to determine the purity of the Pt sponge. It was found to be 99.4% pure Pt. Thus 1.918 g, or 104% of the nominal content of the CCM was recovered.

### Example 5

### (Prophetic)

In this Example, Pt is extracted from the MEA's of a fuel cell stack as a chloroplatinic acid solution without disassembly of the stack. This may be a highly economical method to recover and recycle the most valuable component of the stack. In this method, an oxidizing acidic solution, such as that used in Exs. 1-4, is circulated through the normal anode and cathode gas inlets and outlets of a fuel cell stack. The solution fills the flow field channels and penetrates the gas diffusion layers to dissolve away the Pt contained on the surface of the CCM's adjacent to the GDL's. The solution is optionally pressurized. Appropriate surfactants or other additives are optionally added to effect efficient penetration of the acid solution through the electrode backing and gas diffusion layer. A pump and optional heating system circulates the solution through the stack for a predetermined time sufficient to dissolve the precious metals being recovered. The external device includes appropriate venting facilities to vent and trap any generated Cl₂ gas. Example 3 suggests that only minutes of exposure time would be required to extract the Pt from nanostructured thin film catalyst. After removal of Pt, the stack is optionally shredded, melted and/or burned.

Various modifications and alterations of this invention will become apparent to those skilled in the art without departing from the scope and principles of this invention, and it should be understood that this invention is not to be unduly limited to the illustrative embodiments set forth hereinabove.

We claim:

1. A method of recovering platinum metal from a fuel cell stack which comprises platinum-containing catalyst and which comprises one or more ports allowing access to the platinum-containing catalyst, where the method comprises the step of introducing an oxidizing acidic solution to at least one of the ports, wherein the method does not include electrolysis of the platinum-containing catalyst.

2. The method according to claim 1 additionally comprising the subsequent steps of recovering oxidizing acidic solution from the stack and precipitating a platinum salt from the recovered oxidizing acidic solution.

3. The method according to claim 2 additionally comprising the subsequent step of calcining the platinum salt.

4. The method according to claim 1 wherein said oxidizing acidic solution comprises at least one acid and at least one oxidizing agent.

5. The method according to claim 1 wherein said oxidizing acidic solution comprises at least one acid and at least one peroxide.

6. The method according to claim 1 wherein said oxidizing acidic solution comprises at least one acid and hydrogen peroxide.

7. The method according to claim 1 wherein said oxidizing acidic solution comprises hydrochloric acid and hydrogen peroxide.

8. The method according to claim 1 wherein said oxidizing acidic solution is aqua regia.

9. The method according to claim 3 wherein said oxidizing acidic solution comprises at least one acid and at least one oxidizing agent.

10. The method according to claim 3 wherein said oxidizing acidic solution comprises at least one acid and at least one peroxide.

11. The method according to claim 3 wherein said oxidizing acidic solution comprises at least one acid and hydrogen peroxide.

12. The method according to claim 3 wherein said oxidizing acidic solution comprises hydrochloric acid and hydrogen peroxide.

13. The method according to claim 3 wherein said oxidizing acidic solution is aqua regia.

14. The method according to claim 1 additionally comprising the subsequent step of using the oxidizing acidic solution as an electroplating solution.

15. The method according to claim 3 additionally comprising the subsequent step of using the calcined platinum salt to manufacture fuel cell catalyst.

16. The method according to claim 14 additionally comprising the subsequent step of using the electroplating solution to manufacture fuel cell catalyst.

17. The method according to claim 1 additionally comprising the step of removing the oxidizing acidic solution from at least one of the ports.

18. An apparatus for recovery of platinum metal from a fuel cell stack which comprises platinum-containing catalyst and which comprises one or more ports allowing access to the platinum-containing catalyst, the apparatus comprising a first connector adapted for attachment to a first port and a first reservoir for an oxidizing acidic solution functionally connected to the first connector such that the oxidizing acidic solution may be introduced into the first port.

19. The apparatus according to claim 18 additionally comprising a pump functionally connected to the first reservoir and first connector such that the pump can move oxidizing acidic solution from the first reservoir to the first connector.

20. The apparatus according to claim 18 additionally comprising a second connector adapted for attachment to a second port, where the second connector is functionally connected to the reservoir such that the oxidizing acidic solution may be removed from the second port into the first reservoir.

21. The apparatus according to claim 18 additionally comprising a second connector adapted for attachment to a second port, where the second connector is functionally connected to a second reservoir such that the oxidizing acidic solution may be removed from the second port into the second reservoir.

22. The apparatus according to claim 18 additionally comprising equipment for regulation of oxidizing acidic solution pressure.

23. The apparatus according to claim 18 additionally comprising equipment for regulation of oxidizing acidic solution temperature.

23. The apparatus according to claim 18 additionally comprising equipment for safe venting of evolved gasses.
